(19) United States
(12) Patent Application Publication
(10) Pub. No.: US 2005/0103058 A1
(43) Pub. Date: May 19, 2005

(54) Method for obtaining fiber from mineral raw

(76) Inventors: Paata Gogoladze, Rustavi (GE); Vazha Chagelishvili, Tbilisi (GE)

Correspondence Address: ROTHWELL, FIGG, ERNST & MANBECK, P.C., 1425 K STREET, N.W., SUITE 800, WASHINGTON, DC, 20005, US

(21) Appl. No.: 10/498,231

(22) PCT Filed: Jun. 12, 2002
(86) PCT No.: PCT/GE02/00005

(30) Foreign Application Priority Data
Dec. 11, 2001 (GE) AP 2001 004365

(51) Int. Cl. C03B 5/027

(52) U.S. Cl. 65/441; 65/474

(57) ABSTRACT

The invention can be used for obtaining fiber from mineral raw, for example, basalt. The method for obtaining a fiber provides for melting the mineral raw, homogenization and accumulation of a molten mass, and further feeding of the mass for formation of the fiber. During accumulation of the homogenized mass, electrolysis is carried out. For formation of the fiber, the mass is fed not less than 0.5 meters from a homogenization point of the electrolyzed molten mass.

The invention relates to the production of fiber from the mineral raw, in particular, its use is most preferable for production of textile fiber from basalt.

From the state of the art various methods for obtaining the basalt fiber are known. According to the international application WO 9221628, 1992 the process of making the fiber comprises the following technological operations: melting, homogenization, accumulating of the homogenized mass and then feeding for formation of the fiber. Whereas, to improve the fiber quality in the melting zone TiO₂ is added in the amount of 0.5÷4%, and to the stream feeders the mass is fed from the zone of basalt melt accumulation from a point situated within 0.2÷0.8 height. In addition, there is mentioned that the best results are achieved by processing the basalt mined from the Marneuli (Georgia) occurrence proved by obtaining a fiber having the tensile strength no more than 0.8 (that means that the fiber at processing has the tensile strength 0.8÷1 kg of product).

There is also known the method for forming fibers [U.S. Pat. No. 4,149,866, 1979] according to which melting is performed in inert atmosphere and different deoxidizing agents are added to provide such ratio of FeO/Fe₂O₃ in the production when the textile fiber with high tenacity is obtained.

Besides the mentioned there is also known the U.S. Pat. No. 6,125,660, 2000 that incorporates the said processes and widens the application field of the conventional technologies. In result, to the raw material technical glass wastes are added, for the purpose the temperature parameters are selected. Whereas, FeO/Fe₂O₃ ratio is regulated by means of regulating the air and natural gas ratio.

The main deficiency of the said technological processes is that the tensile strength achieved is less than 0.7, thus limiting in the above technological processes the efficiency of obtaining the textile fiber from the mineral raw.

In addition the conventional above methods require application of additional components in the molten mass and unjustifiable power expenditure, as the preferable redox system can be maintained by increasing the ratio of the natural gas in the fuel.

The proposed invention is free from the said deficiencies and aims to reach the new tensile strength that shall be no more than 0.7÷1 kg of fiber.

The essence of the invention is that for formation of a basalt fiber basalt is melted, homogenized and the homogenized mass is accumulated, whereas in the process of accumulation of the homogenized mass electrolysis is carried out using graphite electrodes, and for formation of the fiber the molten mass is fed from the homogenization point that for the objective of the proposed invention is not less than 0.5 m from the electrodes.

A method according to the proposed invention is carried out in a furnace where as a fuel is used preferably natural gas. Whereas, the method provides for the above mentioned processes, in particular, melting of basalt, homogenization, accumulation and feeding for formation of a fiber via a stream feeder tube, carried out according to the conventional modes. The characterizing feature of the present invention is that in the process of accumulating the molten basalt homogenized mass electrolysis of the molten mass is carried out. Electrolysis may be carried out by means of the graphite electrodes. The objective of the method is the obtaining-maintenance of the preferable ratio of FeO/Fe₂O₃ to obtain a textile fiber having high tenacity without any additives and inert atmosphere. The process of electrolysis is regulated by means of current density regulation, selecting the area of electrodes and the disposition of the stream feeder tube in respect to the electrodes, the distance being not less than 0.5 m from the electrodes.

### EXAMPLE OF THE METHOD EMBODIMENT

For formation of a fiber basalt from Marneuli and Beshtasheni (Georgia) occurrences was used, composition of which is substantially similar. Therein the ratio of FeO/Fe₂O₃ makes in average 4.5±0.5 and the total amount of ferric oxides does not exceed 14%.

Tests were carried out in the conditions of serial production where a furnace for melting the raw by means of natural gas was used that enabled to form the fiber simultaneously by electrolysis according to the proposed invention, as well as in accordance of the conventional technologies.

Basalt rock was loaded in a melting zone of the furnace from where the molten mass by gravity flow was passing to a homogenization zone, therefrom the mass again by gravity flow flowed to two identical accumulation zones A and B (feeders). In the zone A fiber was formed in accordance to the conventional technologies, and in the zone B in accordance to this invention. At the onset of the zone B electrolysis was carried out by means of two graphite electrodes. The area of each electrode sunk in the molten mass was 9±2 cm², by means of a constant-current source variations of the current density were conducted in the scope of 0÷8±1 A/dm². Whereas, formation of the fiber in the zone was carried out in 3 different conditions—without applying potential on the electrode (passive state of the electrode); by maintaining the low current density 4±1 A/dm²; by maintaining the high current density 8±1 A/dm². Application of the process of electrolysis in the technology of fiber formation caused the creation of the new homogenization zone of the electrolyzed mass. From this zone the mass was fed for formation of the fiber. Electric potential between the electrodes did not exceed 2.2V. The molten mass that flowed between the electrodes during 1 hour varied from 9.8 kg to 10.8 kg.

Formation of the fiber and survey were performed during one month, during which by means of practical selection method the minimal distance of the stream feeder tube from the electrodes was determined. The distance was determined empirically, it is defined by the minimal homogenization point of the molten electrolyzed mass and makes 0.5 meters from the electrodes.

The generalized results of FeO/Fe2O3 ratio variations and fiber tensile strength survey are given in the table below, where we can clearly see the advantages of the proposed invention in comparison with the known.

TABLE

| | | Tensile number of | Current density on |
|---|---|---|---|
| | FeO/Fe₂O₃ | fiber/kg | electrodes A/dm² |
| Zone A | 2.9 ± 0.2 | 1 ± 0.05 | — |
| without electrodes | | | |
| Zone B | 3.2 ± 0.1 | 0.9 ± 0.05 | — |
| passive electrodes | | | |
| Zone B | 3.9 ± 0.1 | 0.7 ± 0.05 | 4 ± 0.5 |
| electrodes under | 4.7 ± 0.1 | 0.6 ± 0.05 | 8 ± 1 |
| potential | | | |

The proposed invention in comparison with the conventional technologies enables to: reduce the tensile frequency coefficient without introducing additives in the molten basalt, without increasing the expenditure of the natural gas; increase the ceiling of the fiber production from the mineral raw. All the mentioned above reduces substantially the cost value of the basalt fiber and increases its competitive strength in respect to the other textile fibers of mineral origin.

1. A method for obtaining a fiber from mineral raw provides for melting of the mineral raw, homogenization and accumulation of a molten mass, its further feeding for formation of the fiber, wherein electrolysis is carried out in the process of the homogenized mass accumulation and the mass is fed from a homogenization point of the electrolyzed molten mass for formation of the fiber.

2. The method according to claim 1, wherein electrolysis is carried out by means of graphite electrodes.

3. The method according to claim 1, wherein the homogenization point of the electrolyzed molten mass is not less than 0.5 meters from the electrode.
